(19) United States
(12) Patent Application Publication
(10) Pub. No.: US 2014/0032168 A1
(43) Pub. Date: Jan. 30, 2014

(54) APPARATUS AND METHOD FOR DETECTION OF EMOTIONAL ENVIRONMENT

(71) Applicants: IURII G. CHIRKOV, Ekaterinburg (RU); Klara Khalilova, Ekaterinburg (RU); Dmitry Sagalov, Zarechniy (RU); Sergey Elkin, Vidnoe (RU); Edward Klyshinsky, Moscow (RU); Vadim Maximov, Moscow (RU); Andrey Nazarenko, Ekaterinburg (RU)

(72) Inventors: IURII G. CHIRKOV, Ekaterinburg (RU); Klara Khalilova, Ekaterinburg (RU); Dmitry Sagalov, Zarechniy (RU); Sergey Elkin, Vidnoe (RU); Edward Klyshinsky, Moscow (RU); Vadim Maximov, Moscow (RU); Andrey Nazarenko, Ekaterinburg (RU)

(21) Appl. No.: 13/950,098

(22) Filed: Jul. 24, 2013

(30) Foreign Application Priority Data
Jul. 26, 2012 (RU) 2012131940/08(050

(51) Int. Cl. G06F 19/00

(52) U.S. Cl. CPC G06F 19/36
USPC 702/179

(57) ABSTRACT

A apparatus and method for detecting electromagnetic changes in the environment using electronic sensors is disclosed. The apparatus and method may be utilized in various environments including for electronic entertainment devices with interactive controls, and for interior design, lighting and illumination.

The detection process consists of two stages. First, a sequence of pulses is generated with no predetermined duration at a given time interval, where the average frequency is determined by the frequency characteristics of the shaping amplifiers. This pulse sequence is converted into a sequence of numerical values and statistically analyzed. Data obtained can form the control signals for color components of light emitting devices as well as being displayed on linear scales.

By adjusting the detection sensitivity, and by utilizing various embodiments of the sensor, the apparatus and method may form the basis for a range of useful products.

### CROSS REFERENCE TO RELATED APPLICATION(S)

N/A

### FIELD OF INVENTION

The present invention relates to an apparatus and method for the analysis of electromagnetic noise, in particular to a device that determines the emotional state of persons in the vicinity of the apparatus.

### BACKGROUND

An apparatus and method is disclosed for the detection and analysis of the emotional state of persons in the vicinity of the apparatus. The apparatus and method may be utilized in various environments including electronic entertainment devices with interactive controls, for interior design, lighting and illumination, as well as for electronic devices utilized for the detection of the emotional environment.

The effect of human presences on random processes has been confirmed by many researchers. In particular, a report by the Princeton Engineering Anomalous Research (PEAR) Laboratory, which has been actively involved in this field since 1979, clearly demonstrated that the effect of a deliberate exposure of an operator to a random process is statistically significant, (ie˜10-8 in 125 000 tests), even though it may be negligible (˜0.2%). The same report states that the mere presence of an operator in a room, where the operator is not attempting to affect the result, results in distortion readings with 95% reliability.

In 2005, the Psyleron company, the successor of PEAR, created a device known as REG-1, ie a “random events generator”. REG-1 produces random events similar to tossing a coin, but uses “0” and “1” values instead of “heads” or “tails”. In contrast to the pseudo-random number generator built into some computer software, REG-1 produced truly random events that cannot be predicted or essentially fully described by a finite set of rules. The device showed a small but steady shift of an average value of 0.2% in a normal distribution. These statistical values cannot just be an error in the process of determining the effect. In these cases, simple experiments were used: they analyzed the binary probability of the presence or absence of a signal in a given time interval. As a result, the experiments established the effect of the directional shift of the average in a distribution of random events. A conclusion reached from this is that it is reasonable to say that the effectiveness of electronic detectors is not less than 0.2%.

There are significant benefits to using this effect in diverse applications in areas such as entertainment devices (toys or their controls), art and design projects, or areas where the received signal can be recommending. For example, we might create applications such as an interior color display for illumination or a LED light (or other similar device) that changes to a specific color when exposed to a person or a group of people, or else a marker that is moving on a screen in a specified direction in an electronic game, or else a moving toy that will turn in a specific direction and/or stop at a given moment by intention of the operator. These applications would provide new characteristics and properties to ordinary things.

Another example of a useful application of the effect: if a device is configured to alert its user to check their blood pressure or another threat of an urgent problem, and the device only responds with an alert in 1 occasion in a 100, the device will provide substantial benefits in life and death situations. An acceptable level of risk in various civilized countries begins with the value of 10-6-10-5, therefore the value 10-2 may already be more than impressive for this type of device.

U.S. Pat. No. 5,830,064 describes the principle of operation of a portable electronic device that can register certain operator intentions, expressed in the form of mental directives. This principle can be used in computer games, moving toys and other managed devices, providing additional control implemented without direct contact with the operator. This additional control by non-direct contact significantly enhances the user's interest in electronic games and toys, and in some cases may allow replacement of a direct contact control with a non-direct contact control mechanism.

The operation of U.S. Pat. No. 5,830,064 device is based on the generation of a sequence of random values and then performing statistical analysis on the resulting numeric sequence. To generate the sequence of random values, two sequences are initially generated. The first sequence is inverted in relative to the second sequence by performing an operation similar to an exclusive “OR”. The resulting sequence “sequence 3” is subjected to statistical analysis.

During the statistical analysis the probability characteristics of a random sequence of values (ie the mathematical expectation and its variance) are calculated. The variance is then compared to a threshold indicating the probability of an event outside the specified characteristics. By exceeding the threshold, an event is detected that describes the state of the operator. During creation of the byte sequence (which also occurs as a random event), the appearance of a constant offset that can adversely affect the result of statistical analysis is possible. Therefore, to reduce the impact of this factor and to add an additional factor for this possibility, it is necessary to perform the inversion mentioned earlier.

U.S. Pat. No. 5,830,064 employs a signal generator with an even distribution of power. The inventors rely on the “accidental” nature of the signal, meaning that the signal has an even distribution in a random process with statistical characteristics subject to external influences. This type of signal, as shown in several studies, has a low information content. The implementation described in the prior art method involves executing a large number of auxiliary operations, including the generation of clock pulse sequences and generation of a mask overlay on this sequence, in order to avoid the DC offset that could adversely affect the result. As a result this may affect the cost and power consumption of the U.S. Pat. No. 5,830,064 device. In addition, the U.S. Pat. No. 5,830,064 device has not fully disclosed methods for obtaining the information signal, which could reflect the emotional state of the operator acting on it.

U.S. Pat. No. 5,830,064 uses an evenly distributed signal, although it would be preferable to use the signal type with the form 1/f. The present invention uses the preferred signal form 1/f.

Furthermore, the U.S. Pat. No. 5,830,064 device requires a large number of electronic components for implementation. These include a clock generator set to specific pulse durations, as well as an additional mask sequence generator imposed on the original sequence to eliminate the effects of the first order displacement. Collectively, these steps require more complicated circuitry and larger energy consumption in detector.

The output of the U.S. Pat. No. 5,830,064 device should preferably be visualized on a display device by including, for example, the status of processes using color codes or markers. However, such visual output features are beyond the capabilities of the U.S. Pat. No. 5,830,064 device.

The advantages and objectives of the present invention can be summarized as follows:

a) detection of emotional states, as well as obtaining the resulting signal corresponding to the intensity;

b) increased detection sensitivity and increased detection reliability;

c) increased efficiency, reduced weight, and reduced size parameters while implementing a portable and fully autonomous sensor device;

d) increased information content of the detection process visual display.

The present invention accomplishes these objectives.

### SUMMARY

A apparatus and method is disclosed for the detection and analysis of the emotional state of persons in the vicinity of the apparatus. The apparatus and method may be utilized in various environments including electronic entertainment devices with interactive controls, for interior design, lighting and illumination, as well as for electronic devices utilized for the detection of background conditions.

The apparatus and method can be significantly enhanced if the apparatus is connected with a mobile computer device and/or a network of computers. The personal computer or mobile computer device provides much more memory and processing power compared to the apparatus. By means of a computer interface, and/or wireless interface connected to the apparatus can be used as a drive-analyzer for long term continuous operation of the apparatus. Using a wireless connection or other network connection between a mobile computer and the apparatus, data can be automatically transferred from the apparatus to the mobile computer or a computer network, which can be further processed and presented to the user in a useful form for him. In some embodiments a wired computer interface may be useful for reading data and reconfiguring the apparatus, in addition to recharging the autonomous power supply.

The apparatus may have a number of embodiments. All of them include a power supply, a generation part, and a microprocessor unit within the detection part. These embodiments include the following, among others.

The simplest embodiment of the apparatus may be a portable device, such as a toy. The output unit of the detection part in this embodiment may include only an LED for indicating detected emotional state. Another embodiment of the apparatus can be a game console that is integrated into a computer or a network. In this embodiment, the output unit of the detection part contains a wireless or computer interface to communicate with a personal computer or mobile computer device such as a computer, notebook, tablet computer, smartphone.

Another embodiment of the apparatus may be a portable (mobile) device used to monitor the emotional environment for a person or a group of persons for self-control. In this embodiment, the output unit contains the LED and sound emitter. Another embodiment of the apparatus may be a device connected to an information network to control the emotional environment of persons within rooms, certain zones, or other areas. In this embodiment, the output unit contains LED and wireless and computer interfaces.

The apparatus is comprised of several units, including a generation part, a detection part, and the autonomous power supply. The generation part comprises a noise source and a low-frequency (LF) generator containing low power operational amplifiers. The generation part generates a random pulse signal having predetermined characteristics as described above.

The detection part of the apparatus is comprised of a microprocessor unit that functions with the support of special software (SW), and the output unit containing an indicator, such as an RGB LED indicator, and a sound emitter.

The disclosed apparatus and method executes a sequence of operations including generating an electrical signal representing a sequence of values, then converting the electrical signal into a sequence of values, then transmitting the sequence of values to an analyzer for mathematical processing.

Detection is achieved by first generating a random pulse sequence using a LF generator, then converting it to a numeric value sequence using a sampler, and then performing statistical analysis of the numeric value sequence.

This generation of a random pulse sequence consists of setting the initial value of an electrical signal from the noise source, amplifying and limiting the signal to a random sequence of high and low voltage pulses.

The pulse sequence is then routed to the analyzer unit, where it is then converted into a numeric values sequence by sampler. Samples of numeric values are then extracted from this sequence at certain time intervals. Next, by analyzing the numeric values in the sample, and obtaining the detected signal, the method can implement a signal output having the following distinctive features: an electrical signal obtained from generating a random pulse sequence is at first amplified, then filtered by reducing high-frequency components, and then again amplified, so that a sequence of numeric values is obtained by calculating the difference between the pulse widths of high and low voltage in random pulse sequences in a given interval of time.

A detectable signal of emotional states is obtained by statistical analysis implemented in the dispersion spectrum analyzer. The dispersion spectrum analyzer generates the sequence of dispersion by calculating the numeric values of the dispersion in the sample, then transforming it to a dispersion spectrum, consisting of N independent streams, by measuring the intensity of the dispersion in each of them, and finally, discriminating the obtained intensities in the emotional states detector.

Results may be displayed using a RGB-LED in which the resulting image is formed by combining the color components. The intensity of each component of the LED is calculated based on analysis in analyzer.

Display of the detected signal may also be provided in the form of a moving marker (dot or spot) on the user screen (display) based on the computed statistical values described above.

Other features and advantages of the present invention will become apparent from the following more detailed description, taken in conjunction with the accompanying drawings, which illustrate, by way of example, the principles of the invention.

### BRIEF DESCRIPTION OF THE DRAWING(S)

The foregoing Summary as well as the following detailed description will be readily understood in conjunction with the appended drawings which illustrate embodiments of the invention. In the drawings:

FIG. 1 illustrates an integrated block diagram of an emotional environment detection apparatus;

FIG. 2A illustrates an electronic block diagram of the generation unit of an emotional environment detection apparatus;

FIG. 2B illustrates an electronic block diagram of the detector unit of an emotional environment detection apparatus;

FIG. 3 illustrates a software process block diagram the analyzer of an emotional environment detection apparatus;

FIG. 4 illustrates an electronic block diagram of a low-frequency generator of an emotional environment detection apparatus;

FIG. 5A illustrates a flowchart of the setting unit of the main program of an emotional environment detection apparatus;

FIG. 5B illustrates a flowchart of the cycling unit of the main program of an emotional environment detection apparatus;

FIG. 5C illustrates a flowchart of the setting unit of the calibration program of an emotional environment detection apparatus;

FIG. 5D illustrates a flowchart of the cycling unit of the calibration program of an emotional environment detection apparatus;

FIG. 6 illustrates a graph of the registration of calm surroundings in an emotional environment detection apparatus;

FIG. 7 illustrates a graph of the registration of a stressful emotional state in an emotional environment detection apparatus;

FIG. 8 illustrates a graph of the registration of a stressful emotional state in an emotional environment detection apparatus;

FIG. 9 illustrates a graph of the registration of an emotional state of concentration of consciousness in an emotional environment detection apparatus;

FIG. 10 illustrates a graph of the registration of an emotional state of concentration of consciousness in an emotional environment detection apparatus.

### DETAILED DESCRIPTION OF ILLUSTRATIVE EMBODIMENT(S)

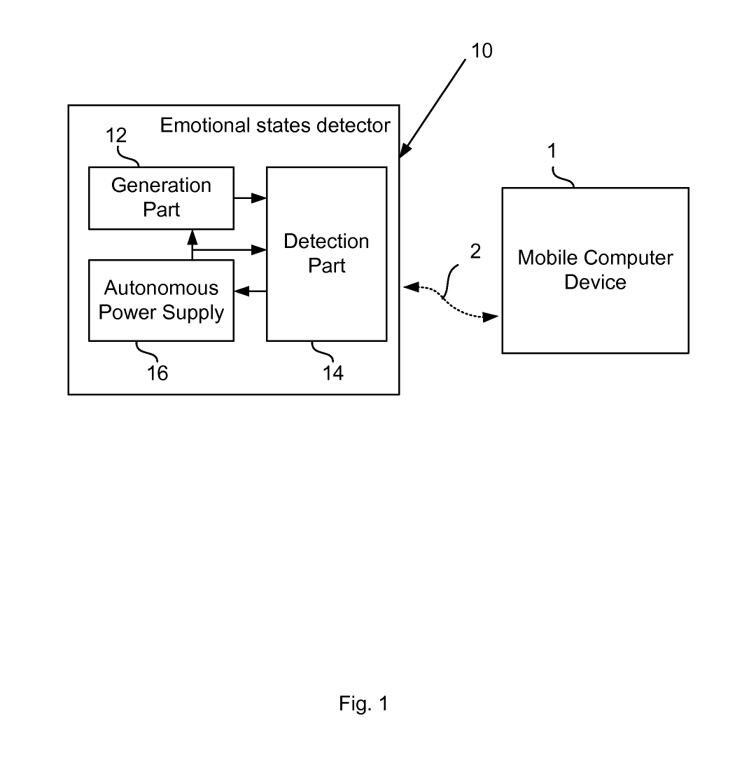

Referring to FIG. 1, a method and apparatus 10 is disclosed for the detection and analysis of the emotional state of persons in the vicinity of the apparatus. The method and apparatus 10 may be utilized in various environments including electronic entertainment devices with interactive controls, for interior design, lighting and illumination, as well as for electronic devices utilized for the detection of background conditions.

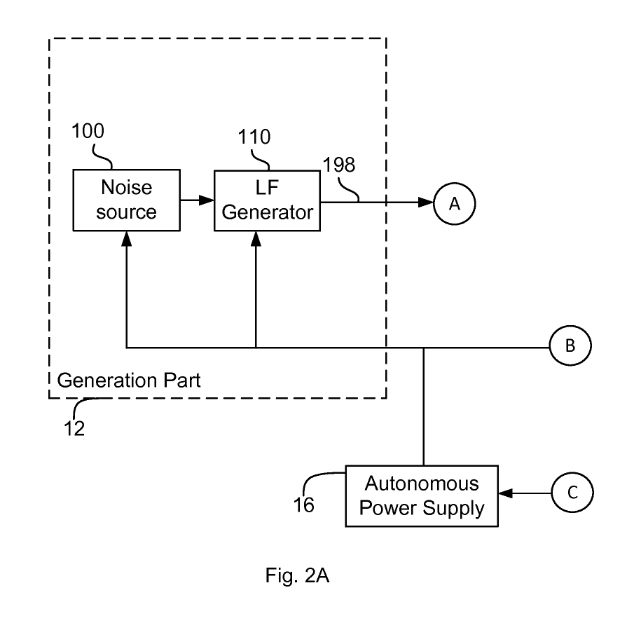

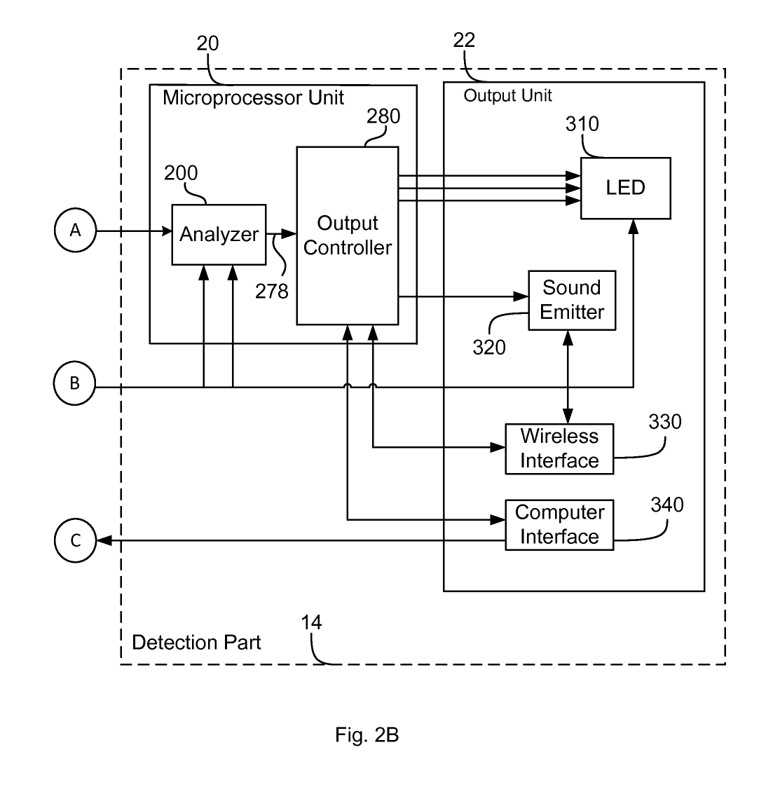

The method and apparatus 10 can be significantly enhanced if the apparatus 10 is connected with a mobile computer device 1 and/or a network of computers as shown in FIG. 1. The personal computer or mobile computer device 1 provides much more memory and processing power compared to the apparatus 10. By means of a computer interface 340 (FIG. 2B) and/or wireless interface 330 connected to the apparatus 10 can be used as a drive-analyzer for long term continuous operation of the apparatus 10 throughout the day. weeks, months or more. Using a wireless connection 2 or other network connection between a mobile computer 1 and the apparatus 10, data can be automatically transferred from the apparatus 10 to the mobile computer 1 or a computer network, which can be further processed and presented to the user in a useful form for him. In some embodiments a wired computer interface 340 (FIG. 2B) may be useful for reading data and reconfiguring the apparatus 10, in addition to recharging the autonomous power supply 16.

The apparatus 10 may have a number of embodiments. All of them include a power supply 16, a generation part 12, and a microprocessor unit 20 within the detection part 14. These embodiments include the following, among others.

The simplest embodiment of the apparatus may be a portable device, such as a toy. The output unit 22 of the detection part 14 in this embodiment may include only an LED 310 for indicating the detected emotional state. Another embodiment of the apparatus can be a game console that is integrated into a computer or a network. In this embodiment, the output unit 22 of the detection part 14 contains a wireless 330 or computer 340 interfaces to communicate with a personal computer or mobile computer device 1 such as a computer, notebook, tablet computer, smartphone.

Another embodiment of the apparatus may be a portable (mobile) device used to monitor the emotional environment for a person or a group of persons for self-control. In this embodiment, the output unit 22 contains the LED 310 and sound emitter 320. Another embodiment of the apparatus may be a device connected to an information network to control the emotional environment of persons within rooms, certain zones, or other areas. In this embodiment, the output unit 22 contains LED 310 and wireless 330 and computer 340 interfaces.

The apparatus 10 is comprised of several units, including a generation part 12, a detection part 14, and the autonomous power supply 16.

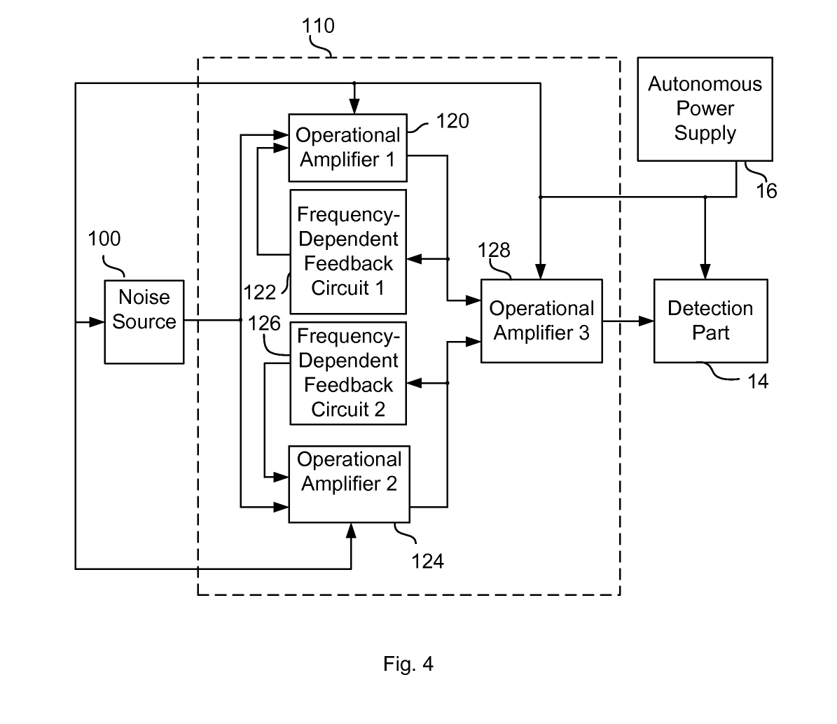

In FIG. 2A, the generation part 12 is illustrated, comprising a noise source 100 and a low-frequency (LF) generator 110 containing low power operational amplifiers (FIG. 4). The generation part 12 generates a random pulse signal 198 having predetermined characteristics as described above.

In FIG. 2B, the detection part 14 of the apparatus 10 is comprised of a microprocessor unit 20 that functions with the support of special software (SW), and the output unit 22 containing an indicator, such as an RGB LED 310, and a sound emitter 320. The random pulse signal 198 from the generation part 12 is directed into the input of the microprocessor unit 20 where software runs a series of mathematical operations on the input signal and produces an analysis. The purpose of the detection process is to calculate the statistics according to the method of detection, to obtain a control signal of emotional states 278, and to produce components in the output controller 280 for the LED 310 and/or sound emitter 320.

Referring to FIG. 2A & 2B, the disclosed method and apparatus 10 executes a sequence of operations including generating an electrical random pulse signal 198 representing a sequence of values, then converting the electrical random pulse signal 198 into a sequence of values, then transmitting the sequence of values to an analyzer 200 for mathematical processing.

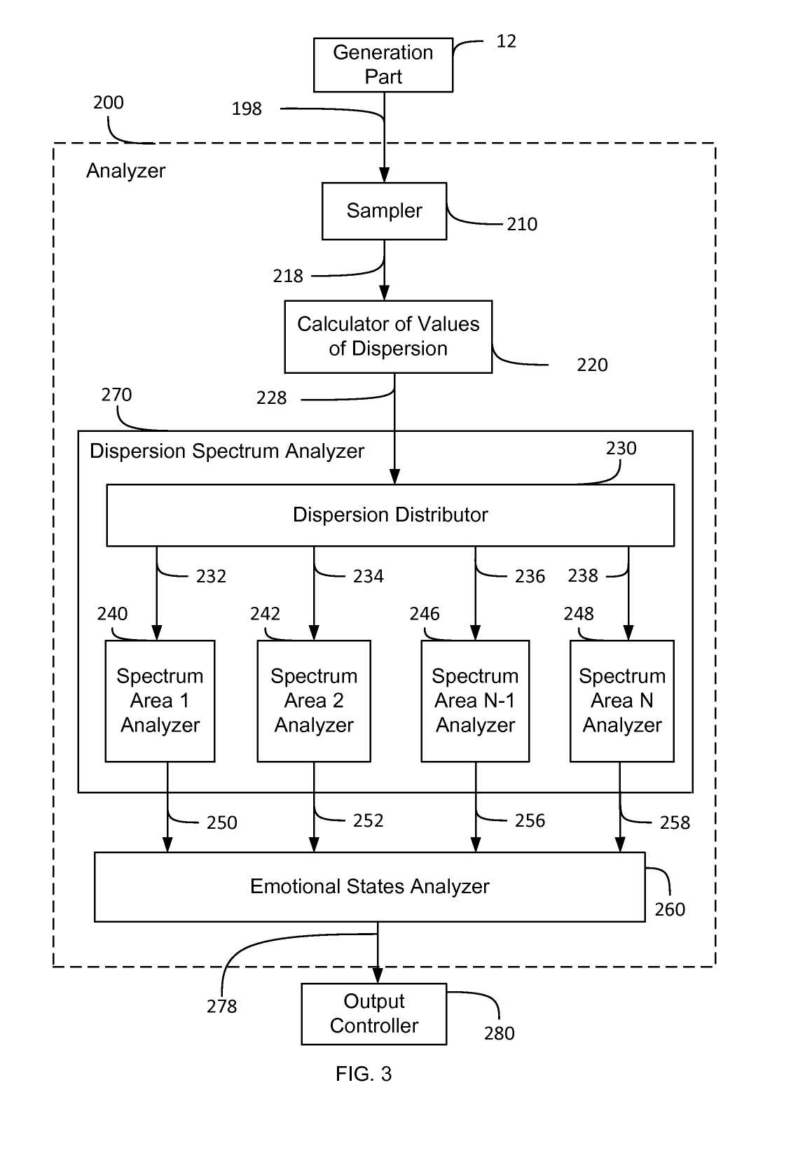

Referring to FIG. 3, a software process block diagram of the analyzer is illustrated. Detection is achieved by first generating a random pulse signal 198 using a LF generator 110 then converting it to a sequence of numeric values 218 using a sampler 210, and then performing statistical analysis of the numeric value sequence 218.

This generation of a random pulse sequence consists of setting the initial value of an electrical signal from the noise source 100, amplifying and limiting the signal to a random sequence of high and low voltage pulses—the random pulse signal 198.

The random pulse signal 198 is then routed to the analyzer 200 (FIGS. 2B & 3), where it is then converted into a sequence of numeric values 218 by sampler 210. Samples of numeric values are then extracted from random pulse signal 198 at certain time intervals. Next, by analyzing the numeric values in the sample, and obtaining the detected signal, the method can implement a signal output having the following distinctive features: an electrical signal obtained from generating a random pulse sequence is at first amplified, then filtered by reducing high-frequency components, and then again amplified, so that a sequence of numeric values 218 is obtained by calculating the difference between the pulse widths of high and low voltage in random pulse sequences in a given interval of time.

Current samples of the sequence of numeric values 218 are processed by calculator of values of dispersion 220 by means of analyzing a certain portion of the sequence of numeric values 218, in a current time slot. The current sample of the sequence of dispersion 228 is produced by the calculator of values of dispersion 220. In the next sample, one time slot is shifted. The sequence of dispersion 228 is composed of the samples obtained, and is routed to the dispersion distributor 230.

The dispersion distributor 230 splits the sequence of dispersion 228 to independent streams of dispersion 1, 2, N−1, N 232, 234, 236, 238, respectively, for further processing, each of them by the appropriate analyzer: spectrum area 1 analyzer 240, spectrum area 2 analyzer 242, N−1 (second-to-last) area analyzer 246, N (last) area analyzer 248.

A detectable signal of emotional states 278 is obtained by statistical analysis implemented in the dispersion spectrum analyzer 270. The dispersion spectrum analyzer 270 generates the sequence of dispersion 228 by calculating the numeric values of the dispersion in the sample, then transforming it to a dispersion spectrum, consisting of independent streams of dispersion 1, 2, N−1, N 232, 234, 236, 238, respectively, by measuring the dispersion intensity 250, 252, 256, 258 in each of them, and finally, discriminating the obtained intensities in the emotional states analyzer 260.

In FIG. 2A, The generation part 12, including noise source 100 and LF generator 110 generates a random pulse signal 198 with variable duty cycle, with a random length period at a given time interval. The signal generation is performed in the following order: the noise source 100 (diode, Zener diode, transistor or resistor), generates an electrical signal. This signal is amplified and low-frequency filtering is applied simultaneously with predetermined frequency parameters. The signal is then re-amplified and transformed into a pulse sequence of high and low voltage levels.

The analysis of the resulting pulse sequence can be achieved by several different analysis options.

Analysis Option One: In FIGS. 2B & 3, the sampling in a sampler 210 is made by analog-to-digital conversion. Next the analysis of the digital sequence of numeric values 218 is made by calculating a dispersion, distributing a dispersion to independent streams of dispersion 1, 2, N−1, N, 232, 234, 236, 238, respectively, and calculating a dispersion intensity 250, 252, 256, 258.

Analysis Option Two: the sampling in a sampler 210 is made by measuring the lengths of high and low level pulses. Then analysis of the sequence of numeric values 218 proceeds as described in “Analysis Option One”.

Analysis Option Three: the sampling in a sampler 210 is made by measuring the period or frequency at a predetermined time interval.

Implementation of Analysis Option one requires performing the analog-to-digital conversion with a corresponding transmitter. This analysis option is the most convenient for implementation in fixed installations where the computing unit can be an available computer or laptop with an analog-to-digital converter, such as in the computer's sound card.

Analysis Options Two and Three are particularly suited for implementation in a mobile miniaturized embodiment when a computer or laptop is unavailable. In these embodiments, the computing unit might be a simple microprocessor having an input for a timer/counter. Implementation of this solution will be extremely low-cost, compact, and with minimum energy consumption.

Implementation of Options Two and Three is preferable compared to implementation of Option One, since measuring the duty cycle or frequency almost completely eliminates the effect of different factors such as temperature, humidity, pressure, and the quality of the electrical connections and the power supply. These factors might have an adverse impact on the detection results.

Results may be displayed using a RGB LED 310 in which the resulting image is formed by combining the color components. The intensity of each component of the LED is calculated based on analysis in analyzer 200.

Display of the detected signal may also be provided in the form of a moving marker (dot or spot) on the user screen (display) based on the computed statistical values described above.

The method provided above is implemented in the apparatus 10 (FIG. 2A, FIG. 4), containing a noise source 100 which has a power input and an output. First 120, second 124 and third 128 operational amplifiers are provided, which all have a power input, while the first operational amplifier 120 and second operational amplifier 124 have inputs and an output. A microprocessor unit 20 (FIG. 2B) has a signal input and power input, and an autonomous power supply 16 that has an output. The microprocessor unit 20 also includes a measurement input, and first, second and third outputs, containing the first and second frequency-dependent feedback circuits 122, 126, each of which has an input and an output.

In FIG. 2B, the LED 310 has first, second and third inputs, also characterized in that the first inputs of the first and second operational amplifiers 120, 124 are connected to the signal source 100 output. The input of the first frequency-dependent feedback circuit 122 is connected to the output of the first operational amplifier 120, the output of the first frequency-dependent feedback circuit 122 is connected to the second input of the first operational amplifier 120, the input of the second frequency-dependent feedback circuit 126 is connected to the output of the second operational amplifier 124, and the output of the second frequency-dependent feedback circuit 126 is connected to the second input of the second operational amplifier 124. The first input of the third operational amplifier 128 is connected to the output of the first operational amplifier 120, the second input of the third operational amplifier 128 is connected to the output of the second operational amplifier 124, and the first, second and third inputs of the LED 310 respectively are connected with the first, second and third outputs of the microprocessor unit 20. The autonomous power supply 16 output is connected to the measurement input of the microprocessor unit 20.

In one embodiment of the apparatus 10, a sound emitter 320 is connected to a microprocessor additional fourth input.

This apparatus 10 can be implemented on widely available and inexpensive integrated circuits of domestic and foreign production: op-amps such as Analog Devices AD8609 or similar, modern high-performance microprocessors: MSP430, ARMS Cortex and others. The source of the signal is a voltage divider with the semiconductor element which passes through itself several dozens of micro-amperes and voltage is supplied to the two identical operational amplifiers 120, 124 with frequency-dependent feedback. These signals are subtracted from each other in the third operational amplifier 128. The output produces variable a frequency pulsed signal where the average frequency is determined by the cutoff frequency of the first and second feedback circuits 122, 126 of the operational amplifiers. The resulting random pulse signal 198 is directed to the input of the microprocessor to be converted into a numeric sequence 218. This sequence is subjected to statistical analysis and the results of this analysis are a dispersion sequence. The results of the dispersion analysis are converted to the signal for the LEDs on display as described above. This signal represents wide pulse modulation (PWM).

The electronic circuit built with these integrated circuits, including the microprocessor, consumes not more than about 1 mA from a 3V battery. When using the common micro lithium batteries with capacity 200-500 mA (type CR2032, CR2325), the apparatus 10 works for about 200-300 hours, which is about 10-15 days of continuous operation.

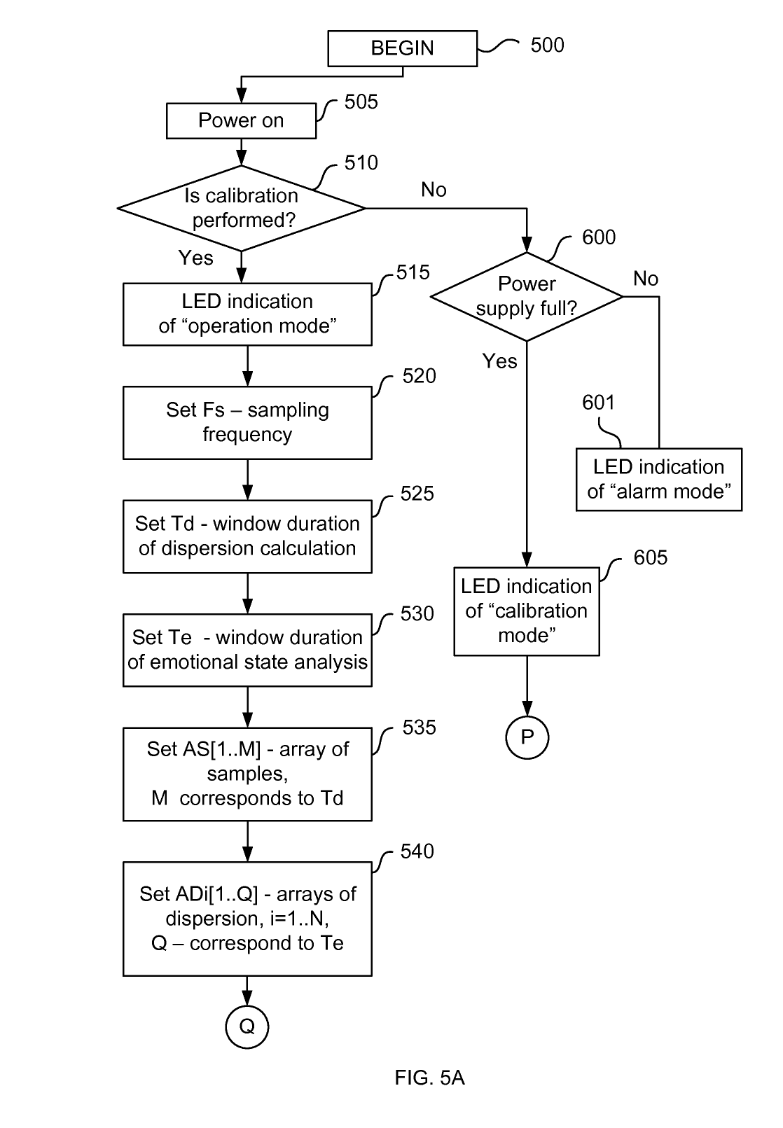

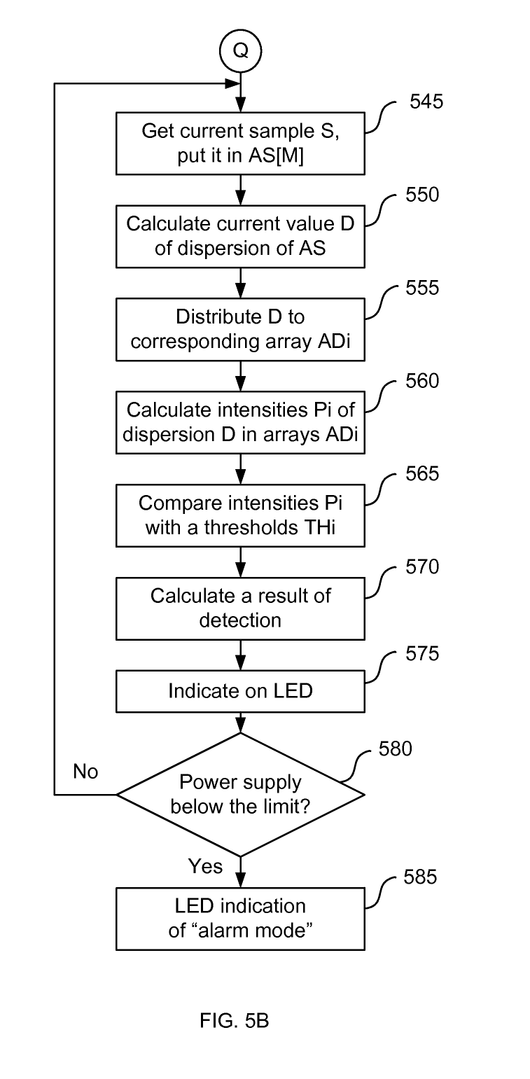

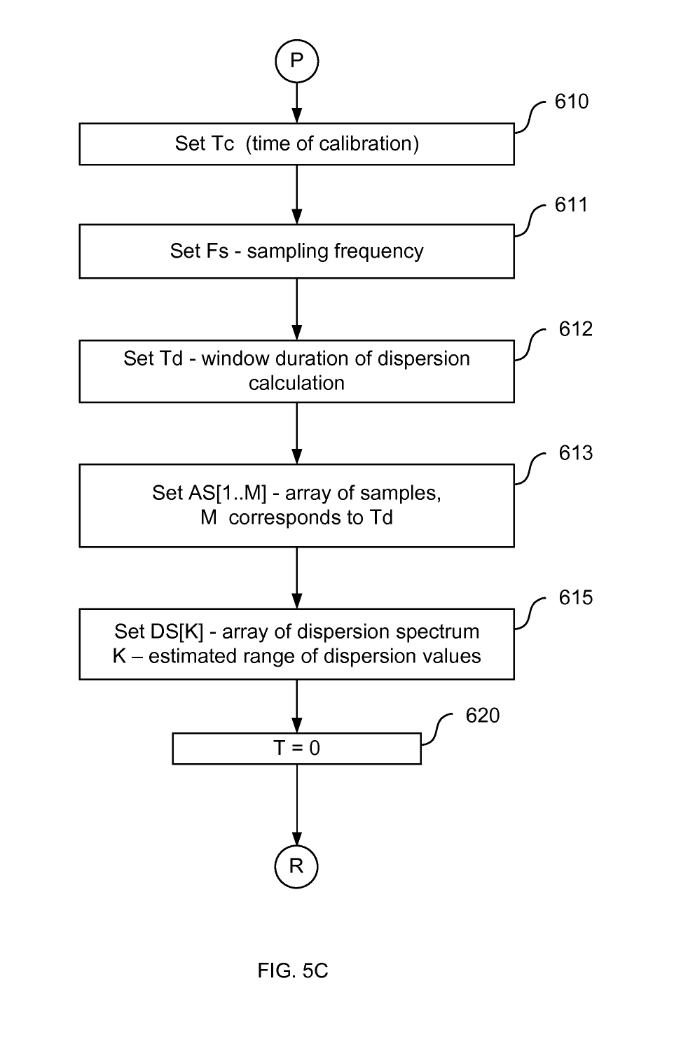

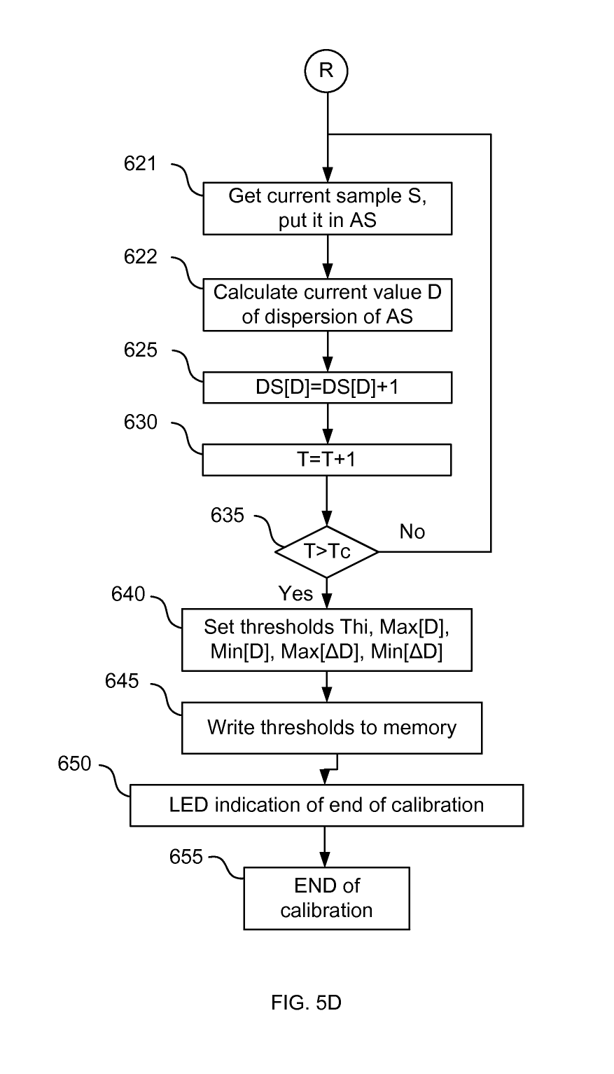

FIG. 5A illustrates a software flowchart of the setting unit of the main program. The software consists of two parts working at different times. The first part is the calibration, which is performed only once immediately after fabrication of the apparatus 10. The purpose of the calibration is the calculation and setting of thresholds which are used in spectrum area analyzers for measuring the intensity of streams of dispersion. The second part is actually the work of the apparatus 10—it can only function when the calibration is complete.

A software flowchart begins in step 500. Immediately after power on in step 505, in step 510 the memory test is executed. This test checks the memory for calibration data. The calibration data includes the thresholds TDi—the threshold intensity of dispersion related to the analyzed channels, Max[D]—the maximum threshold value of the dispersion, Min[D]—the minimum threshold value of the dispersion, Max[D]—the maximum threshold value of change of the dispersion, and Min[D]—the minimum threshold value of change of the dispersion. These thresholds are obtained in the calibration mode produced in a calm environment, away from sources of electromagnetic radiation and people, and the thresholds are individual for each instance of the apparatus 10.

If the memory test determines that the area is empty then calibration is executed. The calibration takes a few hours to get a large number of dispersion values which provide a smooth curve of distribution. Calibration begins after checking the power supply in step 600. If checking fails, the LED indicates an alarm in step 601. If it “passed”, then the LED indicates “calibration mode” in step 605.

FIG. 5C illustrates a flowchart of the setting unit of the calibration program. Setting up parameters is required to make a calibration. Duration of the calibration Tc is set, in step 610. Sampling frequency Fs is set in step 611, and duration of the time window for calculating the dispersion Td is set in step 612. An array AS of storage of samples for calculating the dispersion is set in step 613, and the array DS which will accumulate the values of spectrum distribution of the dispersion is set in step 615. The cycle counter is set in step 620.

In FIG. 5D, based on the sampling rate, a sample is received in step 621. The dispersion of samples taken from the array AS is calculated in step 622. This value is converted to an integer. Next, the value of dispersion is used as the relative address of the array DS. The content of the addressed memory cell of DS is incremented by 1, in step 625.

In order to obtain the time of the calibration process, the cycle counter is set in step 620 (FIG. 5C). Then, in step 630, the cycle counter is incremented. If the cycle counter overflows in step 635, then the process of obtaining the countdown is finished.

Depending on the number of analyzed areas of the spectrum, thresholds are calculated in step 640 based on the obtained spectrum distribution and written in step 645 to memory. Thresholds are reached by the dispersion in a given area of the spectrum over time. The LED 310 indicates the end of calibration, in step 650. Calibration is finished in step 655.

In FIG. 5A, after setting the thresholds, the apparatus 10 can operate in regular mode consisting of the initialization part and the regular part. After switching on the power, in step 505 the apparatus 10 operates. While the apparatus 10 operates, the LED 310 indicates an “operation mode”, in step 515. The program does the initialization part once, and the regular calculation part is performed cyclically.

The Initialization part of regular mode is shown in FIG. 5A. It begins by setting the sampling frequency Fs in step 520. The time duration Td for calculation of the dispersion is set, in step 525, the window duration of emotional state analysis is set in step 530. The array of samples AS, that accumulates values for the calculation of dispersion, is set in step 535. Arrays ADi, needed for storing values of dispersion falling within a certain predetermined field distribution, are set in step 540. The arrays ADi become channels through which move only values of dispersions that fall within a specified range. Values of dispersion that do not fall into any of the areas specified in the further calculations are not involved. Values of dispersion, distributed to the arrays ADi, are used to the calculate current intensity in a given channel.

FIG. 5B illustrates a flowchart of the cycling unit of the main program. After initial setup described above the apparatus 10 operates at a predetermined sampling rate cycle. The current sample value is transformed into integer format in step 545, and is then stored in a circular buffer AS replacing the value that was received Td time ago (step 550). Thus, the cyclical buffer contains only those values that fall within the current time window of duration Td.

In FIG. 5B, the sequence of operation of the computational part is as follows. In step 545, the current sample S is obtained, it is stored in the current position in the array AS. In this case, the array AS contains only samples trapped in a time window of duration Td. The value of dispersion of the array of samples AS is calculated in step 550. Then this value is distributed to one for analysis to one of the channels of dispersion in step 555, i.e. it is stored in one of the arrays ADi. ADi are cyclical buffers as well as AS, but are a different size, which corresponds to the duration of emotional states analysis.

Next, the analysis of dispersion values is performed and, distributed in every area of analysis. In step 560, the intensity of dispersion in each of the channels is calculated by analyzing arrays of ADi.

In one method of analysis, the intensity of dispersion in each channel at a given time may be determined as the number of non-zero elements of the array ADi. In another method of analysis, the intensity of dispersion in each channel at a given time may be determined as the average rate of the change of values in the array ADi.

After calculating, the value of intensity is compared to a threshold in step 565, and the percent degree of excess is determined. The degree exceeding the threshold value is fixed as an information signal for obtaining the emotional states.

This is repeated for each channel of N. For one group of channels, the received values of information signal are summed. For the other group of channels, the received values of information signal also summarized. In step 570, the resultant signal of emotional states is generated as the difference between the information signals of the opposite group of channels, and is displayed on the LED in step 575.

In the cycles of the above-described process, the power source is checked in step 580. If the power supply is below the limit, the alarm is displayed in step 585.

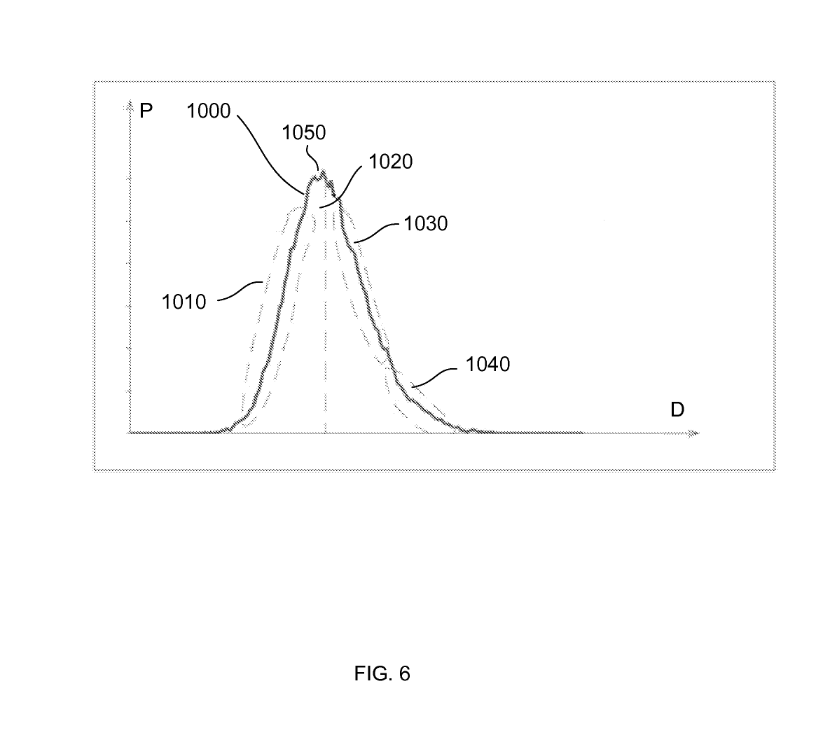

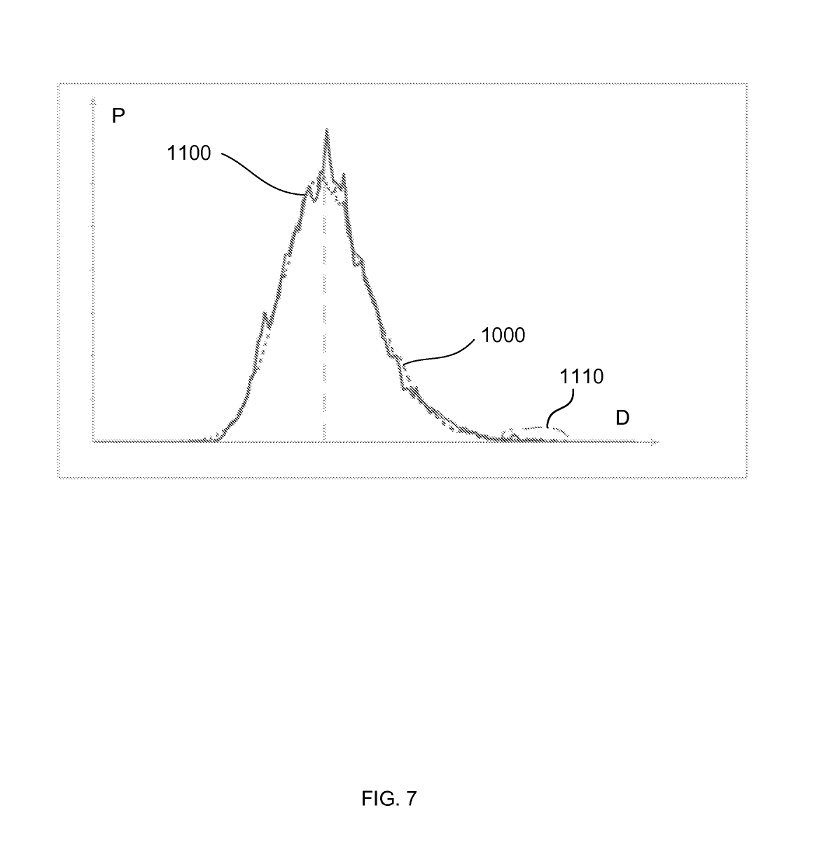

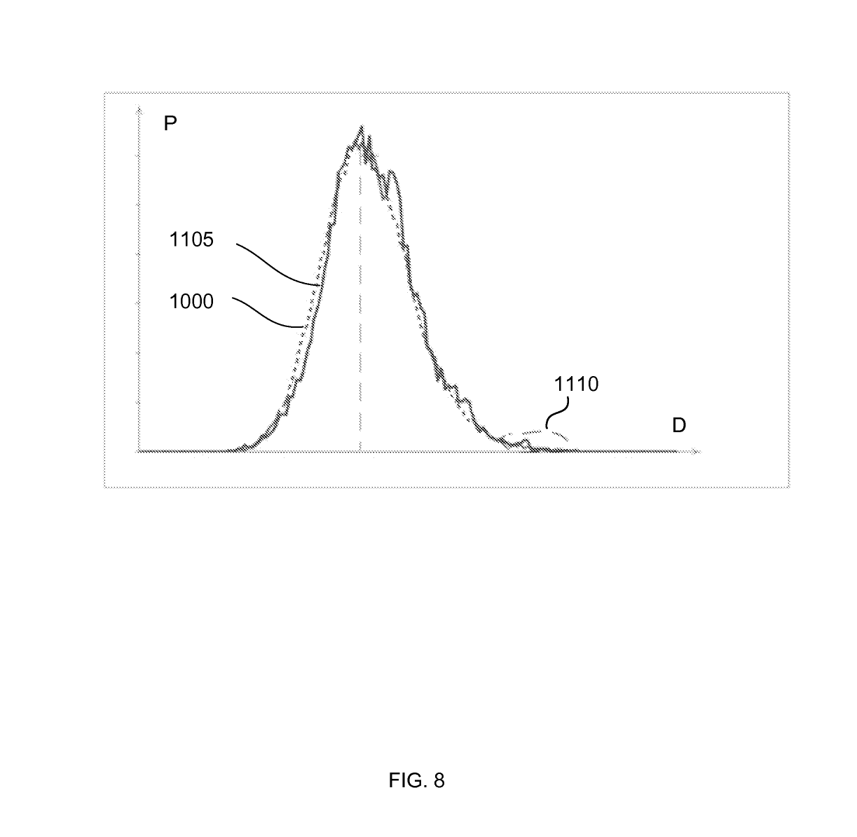

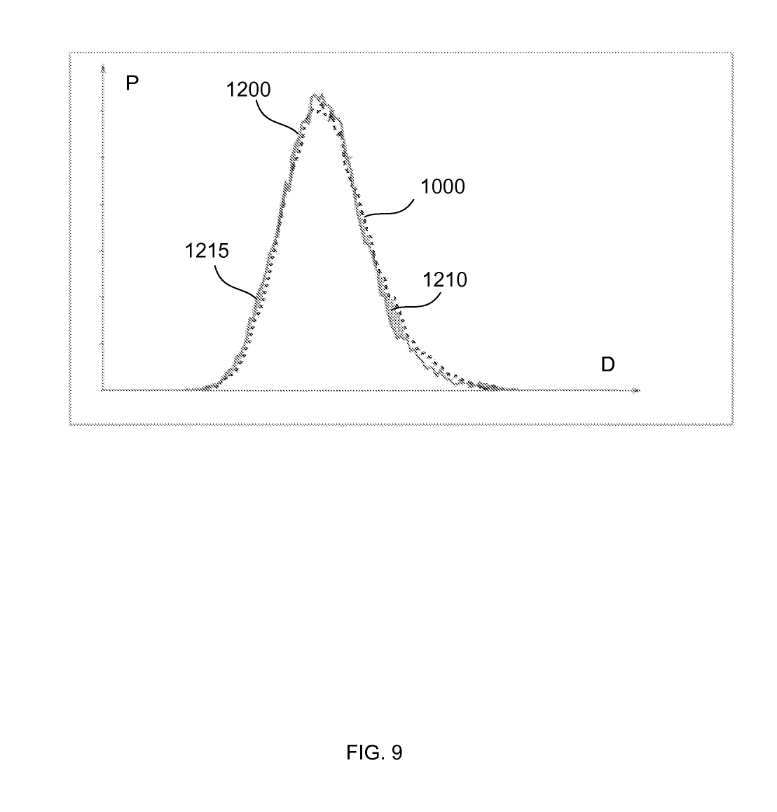

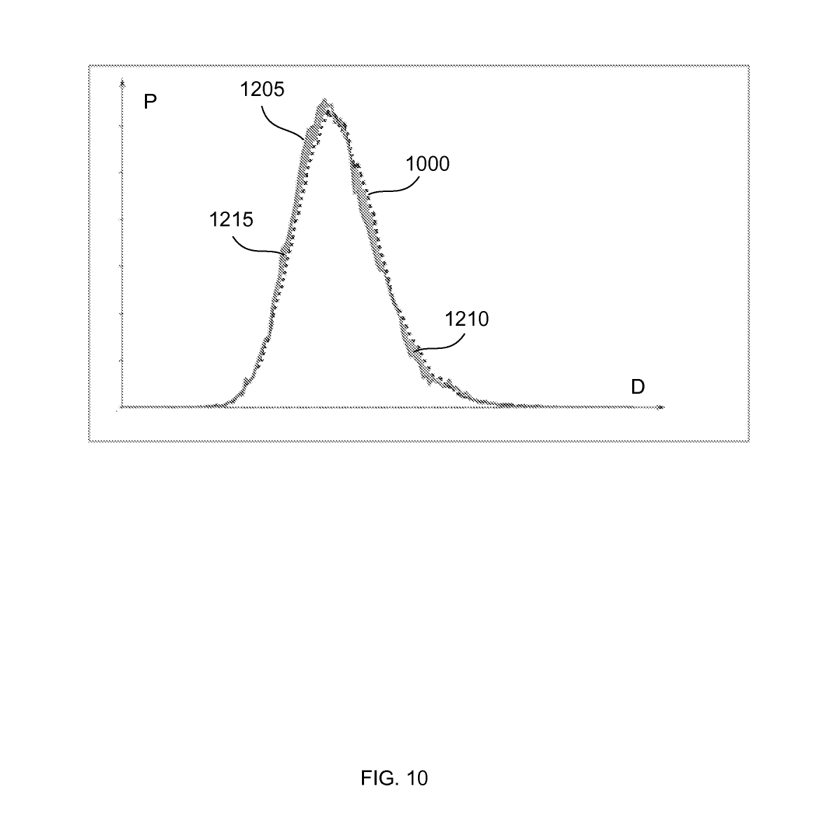

The process of determining the resultant signal reflecting the emotional state is explained in the histograms of FIG. 6, FIG. 7, FIG. 8, FIG. 9, FIG. 10. It should be emphasized that all the histograms have the form of Gaussian curves.

It is first necessary to provide the definition of calm surroundings. Calm surroundings refers to the environment around a point in space where an ambiance of usual conditions for this area (e.g. room, office, working place, cabin of driver or pilot) exists, i.e. “nothing special is occurring”. There may be either an absence of people or the presence of people not performing any significant tasks. Ideally, calm surroundings might exist, for example, in an office at night, in an empty room, in an empty car in a parking lot, in a shop with no customers and a “bored” clerk, in a classroom before lessons, or gym with people warming-up before training etc.

Using an embodiment of the apparatus 10 described above, the distribution of the dispersion obtained by experimentation with calm surroundings is shown in histogram 1000, FIG. 6.

Histogram 1000 has an upward slope area 1010, the average value 1020, and a downward slope area, divided into a rapid decline area 1030 and slow decline area 1040. The maximum resulting value of dispersion expressed as a percentage (P, %) in relation to all possible resulting values is on top 1050 of a histogram, and the average value dividing the histogram in two equal areas characterizes the position of the histogram on the horizontal axis, which has obtained dispersion values marked (D). It should be noted that the histogram is unsymmetrical and its downward sloping area is noticeably longer than its upward sloping area.

For one apparatus 10 working for a period of time to create a histogram in calm surroundings with the temperature from 10 to 30° C., these histogram forms remain the same, as shown in a large number of conducted experiments (from 10 to 100 for every apparatus 10) in the period from December 2007 to November 2011 with at least 25 different apparatuses 10. This fact allows us state with a high reliability (at least 95%) that histograms created in calm surroundings are constant for a given apparatus 10.

However, the shape of the histogram can vary depending on the emotional states in the environment. For example, various cases might include a stressful emotional state because of sudden pain and fear coupled with threats to health or life, both for a particular individual (oneself) and for the people around that person, or a case of a display of aggression during complex negotiations or a tense dispute between one or more parties, or a case of fear experienced during serious money fraud, or a case of an intense feeling of aggression or fear during sports competition etc. For example, the situation in which the sudden realization of an inevitable road accident is experienced by one of the parties involved, (such as when a car suddenly appears in oncoming traffic or an ignorant pedestrian is crossing the road in front of your moving car), or the realization of loss when one's “wallet was stolen with all the money, keys, and credit cards”, or even the experience of viewing a particularly horrifying scene of a film.

A stressful emotional state is accompanied by the strong emission of signal dispersion, far beyond its average value to the middle of the area of slow decline. It was registered on a large number of occasions in different situations and in many cases with different apparatuses 10 simultaneously. The number of registrations in different apparatuses 10 over the observation period is has been counted in dozens and hundreds per apparatus 10. As an example, there are two histograms of stressful emotional state 1100, 1105 from different apparatuses 10 (FIG. 7, FIG. 8), that were built during the boxing sparring of beginning athletes. For comparison, the histogram 1000, which was created in calm surroundings, is added to the graph.

The peculiarity of the situation in which the apparatuses 10 were working was that it was the first boxing sparring training for the participating athletes. Before that, the participants were only observing boxing sparring training. Naturally, the fear of missing hits was coupled with the pain of receiving them and the realization of received damage, and the aggression towards the opponent was mutual and pretty intense. But at the same time, athletes were afraid of each other and weren't able to show the maximum of their capabilities. So, the situation contained pure fear and aggression.

Both histograms 1100, 1105 clearly show the area of distinctive spikes 1110 at the end of the area of decline, which are situated the same relative distance from the average value 1020. The analysis of histograms shows that the area of distinctive spikes 1110 on the histogram 1100 is 5-7 times bigger than the corresponding area of the histograms 1000, 1005 shown here with a dotted line. In addition, the areas of spikes from histograms 1100, 1105 are approximately equal, from which it is possible to conclude that different apparatuses 10 register roughly the same force of emotional influence.

The following emotional state—concentration of consciousness has also been stably registered. Concentration of consciousness in a certain sense is opposed to a stressful emotional state. A person in this state is most focused, attentive and has the highest (in relation to oneself) ability to receive incoming information, as well as to implement their current intent. This state was registered many times during the intentional concentration of consciousness, meditation, and in different situations of intended actions. The index case of implementation of current intentions is driving a car in the city, which requires a high level of attention and self-control. The moments of creativity were also registered, for example, during the working process of a highly qualified programmer creating a computer program. The total number of registrations (dozens and hundreds per apparatus during the observation period) of the state of concentration of consciousness is not inferior to other registrations.

The state of concentration of consciousness is reflected by the shift of signal dispersion to the upward slope area 1010. The more pronounced the state of concentration of consciousness, the more the values of dispersion per time unit increase in the lifting area. As an example there are histograms FIG. 9 and FIG. 10 that were created during 80 minute lessons of advanced training for programmers of one company specializing in electrical engineering. The graphs show the histograms 1200, 1205 created in the state of concentration of consciousness by different apparatuses. The histograms 1000, 1005 reflecting a calm surroundings of the corresponding apparatus is shown here with a dotted line.

The peculiarity of the experiment was that the process of concentration of consciousness was double: trainees were truly motivated to receive the necessary information, since it promised them career development for at least the next year or two, and the trainers were working hard to impress their colleagues.

Histograms 1200, 1205 shifted to the area of lesser dispersion values (in relation to histograms 1000, 1005), and the offset values can be compared. In addition, while analyzing the form of the histograms, it can be noted that they are significantly deformed in comparison with calm surroundings histograms 1000, 1005, respectively. Both histograms have noticeable pits 1210 in the area of rapid decline and the upward slope area has outgrowths 1215. The areas of those pits 1210 and outgrowths 1215 are shaded. The analysis shows that those areas are comparable, that is the force of concentration of intentional influence is reflected approximately equally.

The analysis of histograms FIG. 7, FIG. 8, FIG. 9, FIG. 10 shows that the two registered states (of stress and concentration) reflected in those histograms may be seen, in a way, as opposed to each other, since each of them is accompanied by a splash of signal dispersion in “its own” area of the distribution of dispersion. There is also a subtraction of dispersion values from the opposite area.

For example, if there are pits in the area of decline and overgrowths in the lifting area, then it suggests concentration. If, on the contrary, there are splashes in the area of decline, then it suggests the state of stress.

Therefore, it seems quite natural to display the resulting signal of emotional state as the difference between information signals (in its particular combination), which were obtained as the excessive intensity of dispersion splashes in the given areas of the spectrum of distribution of dispersion, in relation to the intensity registered in calm surroundings in the same areas. Moreover, the further the analyzed area is from the average value 1020, the greater its weight in the corresponding information signal.

This principle of extracting the useful signal from different areas of analysis is embodied in analyzer 200 shown in FIG. 3, by spectrum area analyzers 1, 2, N−1, N 240, 242, 246,248, respectively. These analyzers treat the area corresponding to the areas of distinctive spikes 1110, pits 1210 and outgrowths 1215, shown in FIG. 7, FIG. 8, FIG. 9, FIG. 10. By distributing the dispersion in these areas, and calculating the intensity at each of them, the main result of the invention is achieved.

It is also convenient to implement the display of the resulting signal with a colored LED, in which the green color would represent the state of the concentration of consciousness, and the red color would represent the state of stress. By calculating the green and red components independently, but taking into account the magnitude of the corresponding information signal that depends on the intensity of emotional influence, we can obtain the sum of two components. That is, the bright green glow will indicate the state of concentration of consciousness (the red component will be much less than green), and the bright red glow will indicate the state of stress (the green component will be reduced to a minimum). If the environment will not have any significant events present, then the glowing will be either absent altogether or will be yellow—that is, the sum of green and red.

Also, in addition to the above, in some embodiments, to reduce the response time of the apparatus 10 to an emotional disturbance, it makes sense to display on the LED 310 or a mobile computer device 1 a signal of emotional states 278 obtained directly from the sequence of dispersion 228. This may be as the instantaneous values of dispersion 218 obtained in step 550 and the value of change of dispersion per certain time, calculated in step 570.

Displaying on the LED 310 the signal of emotional states 278 as the instantaneous values of dispersion, the signal is presented as a combination of red and green components, which are calculated as follows:

I_{red}=Q*[D−Min[D]/(Max[D]−Min[D]),

I_{green}=Q*[(Max[D]−D)/(Max[D]−Min[D]), where

I_{red}—red component intensity

I_{green}—green component intensity,

Q—duty cycle of the output pulses that sets the brightness of the indication.

D—instantaneous value of dispersion

Max[D]—the maximum threshold value of the dispersion obtained in the calibration, at step 640 (FIG. 5D)

Min[D]—the minimum threshold value of the dispersion obtained in the calibration, at step 640

Displaying on the LED 310 the signal of emotional states 278 as the instantaneous value of change of dispersion, the signal is presented as a combination of red and green components, which are calculated as:

I_{red}=Q*[D−Min[D]/(Max[D]−Min[D]),

I_{green}=Q*[(Max[D]−D)/(Max[D]−Min[D]), [symbol] e

I_{red}—red component intensity

I_{green}—green component intensity

Q—duty cycle of the output pulses that sets the brightness of the indication

D—the calculated instantaneous value of change of dispersion

Max[D]—the maximum threshold value of change of the dispersion obtained in the calibration, at step 640

Min[D]—the minimum threshold value of change of the dispersion obtained in the calibration, at step 640

A blue luminescence component may be further added if the value of dispersion 218 is beyond the threshold values obtained during calibration. Thus, if the value of dispersion 218 exceeded the value of Max [D], the glow will have a purple hue, and if it fell below the Min [D]—the glow acquires an azure hue. The same colors will be displayed at the output of the signal of emotional states as the value of the dispersion's change: if the change of dispersion ΔD exceeds the threshold dispersion Max [ΔD], or fallen below the threshold Min [ΔD], respectively.

By using this method of outputing a signal of emotional states, the apparatus 10 user can exercise self-control and/or control of the people around the user, by tracking the almost instantaneous response of the apparatus 10 to the external emotional environment.

While embodiments of the invention have been described in detail above, the invention is not limited to the specific embodiments described above, which should be considered as merely exemplary illustrations set forth for a clear understanding of the principles of the invention. Further variations, modifications, extensions, or equivalents of the invention may be developed without departing from the scope of the invention. It is therefore intended that the invention not be limited to the particular embodiments disclosed as the best mode contemplated for carrying out this invention, but that the invention will include all the embodiments falling within the scope of the appended claims.

What is claimed is:

1. A method in a computing system for detecting emotional states of the environment, the method comprising:
generating a random pulse signal from a noise source,
converting said pulse signal to a sequence of numeric values,
imposing a time window onto said sequence of numeric values,
calculating the current value of a dispersion value within said time window,
performing statistical analysis on said sequence of numeric values,
comparing information signals from different spectrum areas,
detecting a signal representing the emotional state of the environment;
whereby the emotional state of the environment may be determined.

2. The method of claim 1, wherein said sequence of numeric values is obtained by performing an analog-to-digital conversion.

3. The method of claim 1, wherein said sequence of numeric values is obtained by calculating the instantaneous frequency of the random pulse signal.

4. The method of claim 1, wherein said sequence of numeric values is obtained by measuring the period of said random pulse signal in a given period of time.

5. The method of claim 1, wherein said dispersion intensity at a given spectrum area is defined as the number of the dispersion values inside a given analysis area in a set period of time.

6. The method of claim 1, wherein said dispersion intensity is defined as the amount of its change per time unit.

7. The method of claim 1, wherein said emotional state signal is formed by calculating the difference between two values of dispersion intensity, which were calculated as the sums or differences of dispersion intensities in different spectrum areas.

8. An emotional state detector, comprising:
a noise source;
a plurality of operational amplifiers;
a power supply;
a network interface;
a processor;
a storage device;
a user display device; and
computer executable instructions operative on the processor for:
generating a random pulse signal from a noise source,
converting said pulse signal to a sequence of numeric values,
imposing a time window onto said sequence of numeric values,
calculating the current value of a dispersion value within said time window,
performing statistical analysis on said sequence of numeric values,
comparing information signals from different spectrum areas,
detecting a signal representing the emotional state of the environment;
whereby the emotional state of the environment may be determined.

9. The emotional state detector of claim 8, said computer executable instructions further comprising the step of obtaining said sequence of numeric values by performing an analog-to-digital conversion.

10. The emotional state detector of claim 8, said computer executable instructions further comprising the step of obtaining said sequence of numeric values by calculating the instantaneous frequency of the random pulse signal.

11. The emotional state detector of claim 8, said computer executable instructions further comprising the step of obtaining said sequence of numeric values by measuring the period of said random pulse signal in a given period of time.

12. The emotional state detector of claim 8, said computer executable instructions further comprising the step of defining said dispersion intensity at a given spectrum area as the number of the dispersion values inside a given analysis area in a set period of time.

13. The emotional state detector of claim 8, said computer executable instructions further comprising the steps of defining said dispersion intensity as the amount of its change per time unit.

14. The emotional state detector of claim 8, said computer executable instructions further comprising the step of forming said emotional state signal by calculating the difference between two values of said dispersion intensity, which were calculated as the sums or differences of dispersion intensities in different spectrum areas.

15. The emotional state detector of claim 8, further comprising a sound emitter device.

16. The emotional state detector of claim 8, further comprising a serial interface configured for a wired connection to a computer.

17. The emotional state detector of claim 8, further comprising a high-frequency transceiver with a serial interface configured for a connection to said processor.

18. The emotional state detector of claim 8, wherein said user display comprises a plurality of LED type display units.
